(19) United States
(12) Patent Application Publication
(10) Pub. No.: US 2004/0165938 A1
(43) Pub. Date: Aug. 26, 2004

(54) Positioning device for connecting spokes to bicycle rim

(76) Inventor: Lai-Chien Chen, Hua Tan Hsiang (TW)

Correspondence Address: CHARLES E. BAXLEY, ESQ., 90 JOHN STREET, THIRD FLOOR, NEW YORK, NY, 10038, US

(21) Appl. No.: 10/740,114

(22) Filed: Dec. 17, 2003

(30) Foreign Application Priority Data
Feb. 26, 2003 (TW) 092203164

(51) Int. Cl. F16B 7/06

(52) U.S. Cl. 403/43

(57) ABSTRACT

A positioning device includes a sleeve member engaged with one of holes defined in the wheel rim and a base has its shank extending through a passage of the sleeve member. A threaded hole is defined in the shank so that an end of a spoke is threadedly engaged with the threaded hole in the shank. A sealing ring made of non-metallic material is mounted to the sleeve member so as to seal the hole in the rim. The coating of the rim is not scrubbed by any of the parts of the positioning device and the installing processes are easy and can be finished within a short period of time.

### FIELD OF THE INVENTION

The present invention relates to a positioning device for connecting a spoke to a Magnesium Alloy made wheel rim of a bicycle without removing an anti-rusting coating on the rim.

### BACKGROUND OF THE INVENTION

The modern bicycle rims are made of Magnesium Alloy which is easily to be machined and light in weight compared with Aluminum. Nevertheless, the Magnesium is more likely to get rust than Aluminum so that there will be an anti-rusting coating coated on the Magnesium Alloy made rim. Therefore, it is important to prevent from scrubbing the coating when installing the spokes. A conventional assembly for spokes and bicycle rim is shown in FIGS. 7 and 8 and generally includes a positioning sleeve 100 engaged with a hole defined through the rim 200 and an enlarged head 301 of one of the spokes 300 is stopped by the positioning sleeve 100 from an inside of the rim 200. It requires a lot of force to insert the spoke 300 into the sleeve 100 and takes a lot of time. FIG. 9 shows another conventional assembly of spokes and rim, a sleeve 1000 is threadedly engaged with the hole defined in the rim 2000 and an end member 1001 extends through a passage defined through the end member 1001 and includes a threaded hole. An end of the spoke 3000 has a threaded end which is threadedly engaged with the threaded hole of the end member 1001. It is noted that when installing the sleeve 1000, the coating on the rim 2000 could be removed by the sleeve 1000 during installing so that the area around the hole in the rim 2000 is easily rusted.

The present invention intends to provide a positioning device for securing the spokes to the rim and the device effectively prevents from scrubbing the coating away from the rim.

### SUMMARY OF THE INVENTION

The present invention relates to a positioning device for connecting a spoke to a wheel rim and the positioning device comprises a sleeve member having a flange extending outward from an end thereof and the other end of the sleeve member extends through one of holes in the rim. The flange is stopped by a periphery of the hole. A base has an enlarged head and a shank extends from the enlarged head. The shank extends through the passage of the sleeve member and a threaded hole is defined through the shank. An end of a spoke is threadedly connected to the threaded hole in the shank. A sealing ring is mounted to the sleeve member and seals the hole of the rim.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the positioning device of the present invention, a spoke and a rim;

FIG. 2 is an exploded view to show the positioning device of the present invention to be engaged with one of holes in the rim and a spoke to be connected to the positioning device;

FIG. 3 is a cross sectional view to show a spoke is connected to the positioning device of the present invention;

FIG. 4 is an exploded view to show another embodiment of the positioning device of the present invention, a spoke and a rim;

FIG. 5 is an exploded view to show the positioning device as shown in FIG. 4 to be engaged with one of holes in the rim and a spoke to be connected to the positioning device;

FIG. 6 is a cross sectional view to show a spoke is connected to the positioning device as shown in FIG. 4;

FIG. 7 shows a wheel having a rim with a plurality of spokes and a tire engaged with the rim;

FIG. 8 is a cross sectional view to show a conventional connection of a spoke and the rim, and

FIG. 9 is a cross sectional view to show another conventional connection of a spoke and the rim.

### DETAILED DESCRIPTION OF THE PREFERRED EMBODIMENT

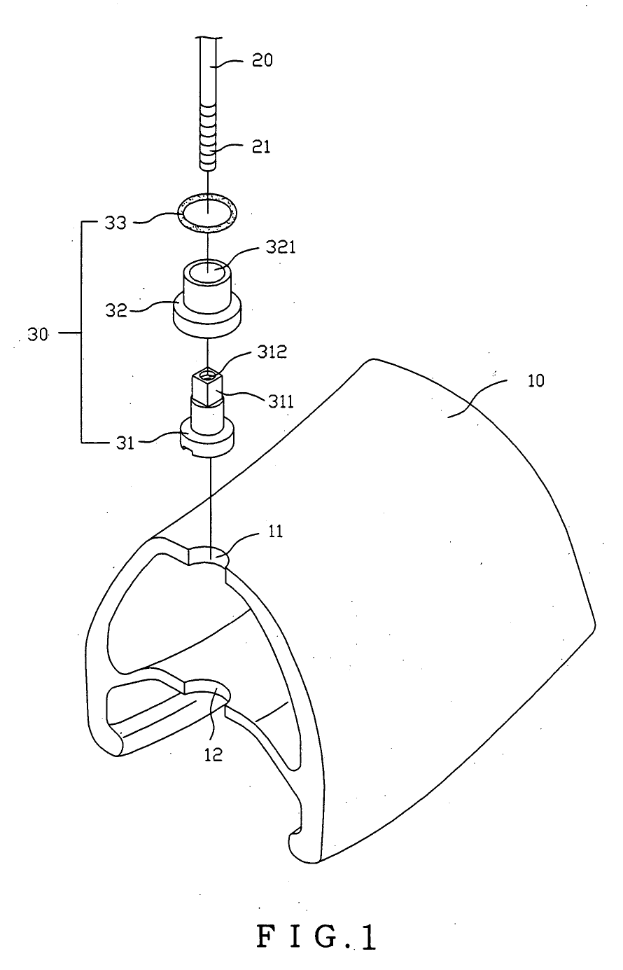

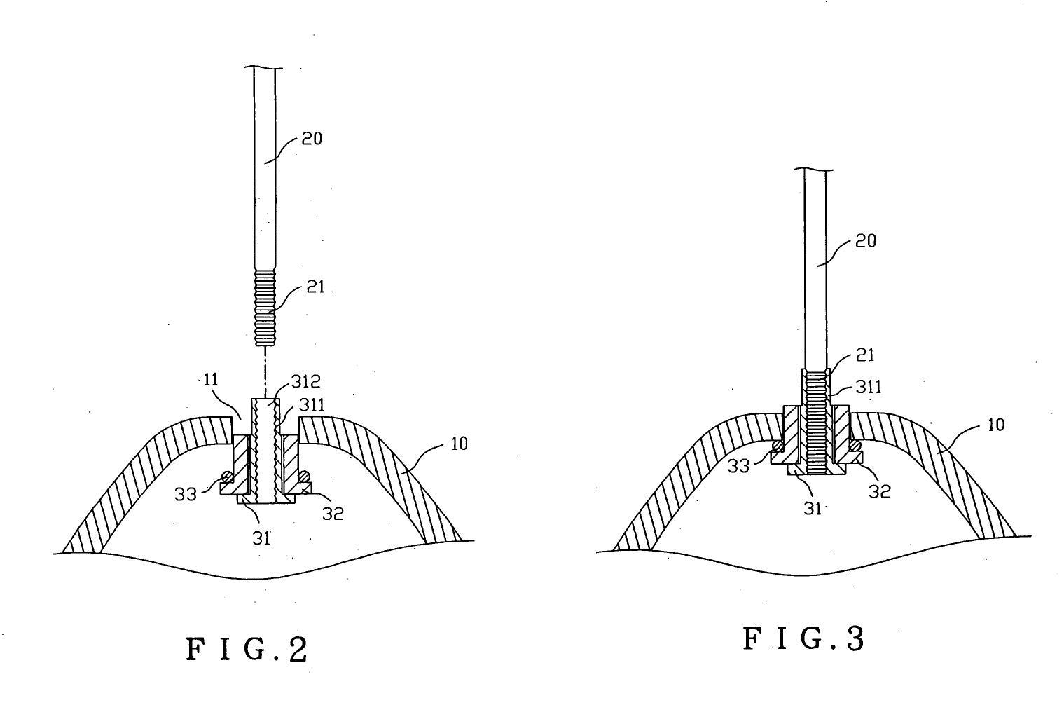

Referring to FIGS. 1 to 3, a bicycle wheel rim 10 in this embodiment is made of Magnesium Alloy and includes two lips respectively extending from the inside and the outside of the rim 10 so as to be connected to a tire which is not shown. The rim 10 includes an outer periphery having a plurality of holes 12 and an inner periphery having a plurality of holes 11.

The positioning device 30 of the present invention comprises a sleeve member 32 having a flange extending outward from an end thereof and a passage 321 is defined through the sleeve member 32. The sleeve member 32 is sent to the hole 11 in the inner periphery of the rim 10 via the hole 12 in the outer periphery of the rim 10, and the other end of the sleeve member 32 extends through one of the holes 11 of the rim 10.

A base 31 has an enlarged head 31 and a shank extends from the enlarged head 31. The shank extends through the passage 321 of the sleeve member 32 and a threaded hole 312 is defined through the shank. The shank of the base 31 includes a polygonal section 311 which extends beyond an end of the sleeve member 32 such that the assembler may hold the shank by using a tool to clamp the polygonal section 311. A sealing ring 33 made of non-metallic material such as plastic material is mounted to the sleeve member 33 and seals the hole 11 of the rim 10 when a threaded end 21 of the spoke 20 is threadedly connected to the threaded hole 312. The sealing ring 33 is then clamped between the inner periphery of the rim 10 and the enlarged head of the base 31. It is noted that the sleeve member 32 is simply inserted into the hole 11, the anti-rusting coating on the periphery of the hole 11 will not be scrubbed and the sealing ring 33 prevents a direct contact between the enlarged head of the base 31 and the rim 10.

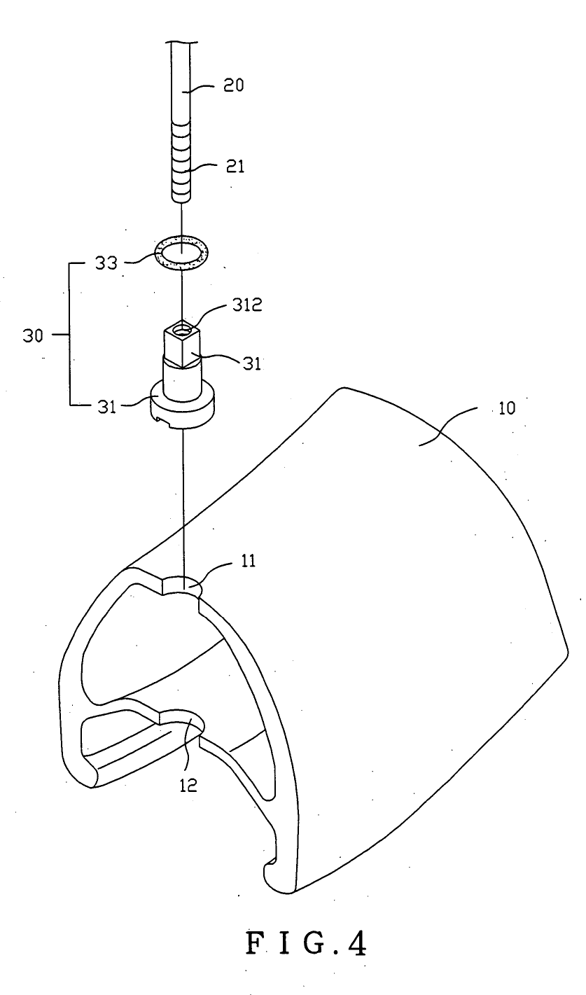

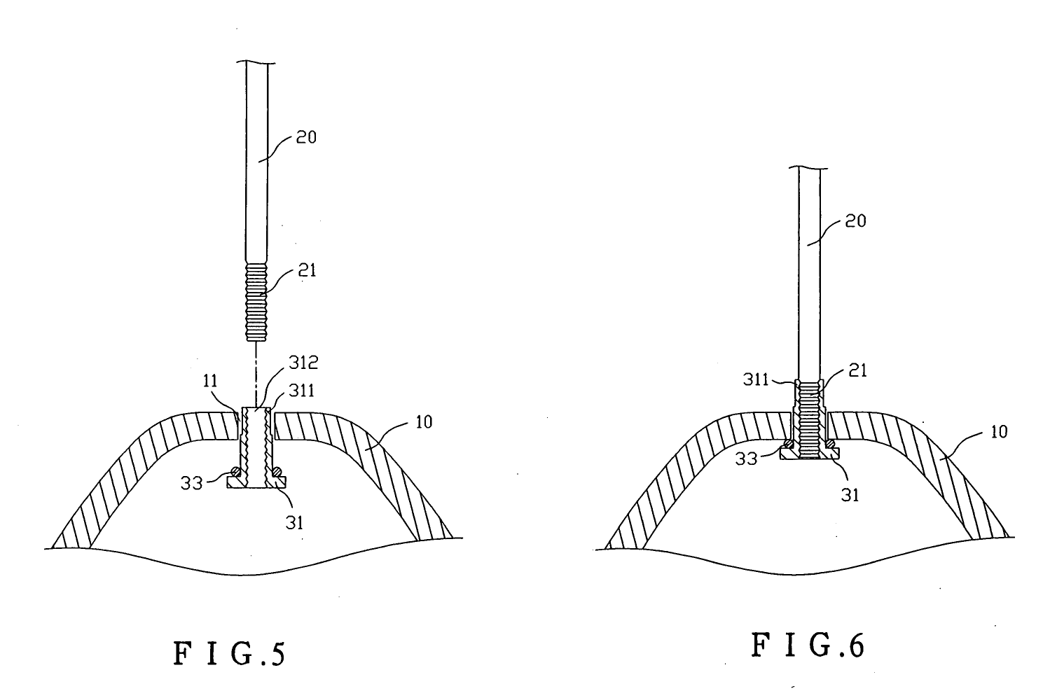

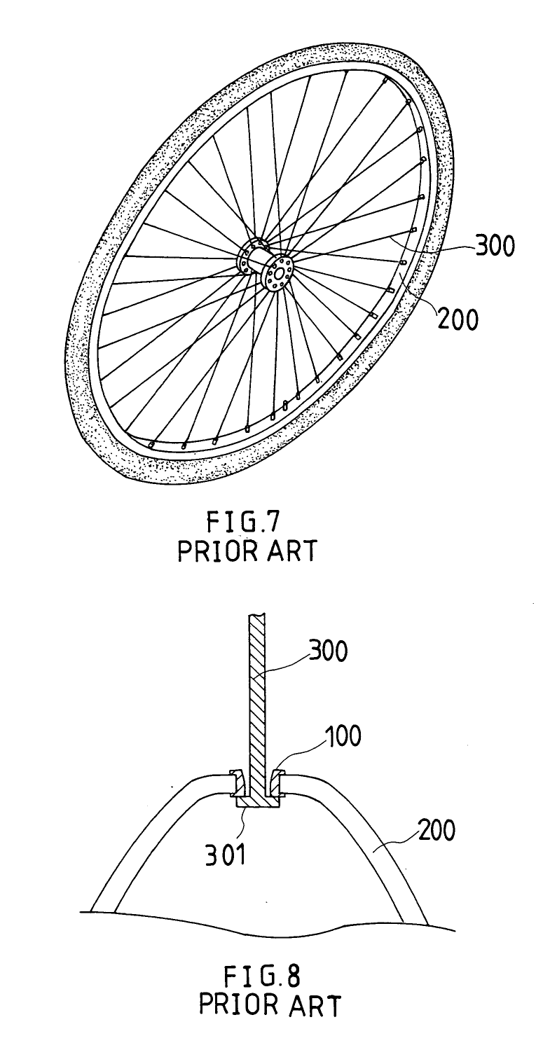

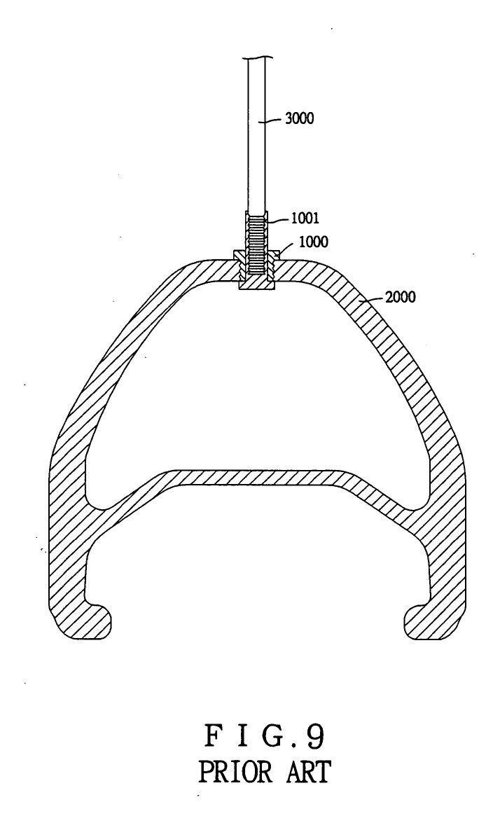

FIGS. 4, 5 and 6 show another embodiment of the present invention wherein the positioning device 30 of the present invention comprises only the base 31 and the sealing ring 33, both of which are the same as those mentioned in FIGS. 1 to 3. The sleeve member 32 mentioned in FIGS. 1-3 is omitted in this embodiment. The base 31 has an enlarged head and a shank extending from the enlarged head. A threaded hole 312 defined through the shank which extends through one of the holes 11 in the rim 10. The shank includes a polygonal section 311 which is extended beyond the hole 11 of the rim 10. The threaded hole 312 is connected to a threaded end 21 of the spoke 20. A sealing ring 33 is mounted to the shank of the base 31 and seals the hole 11 of the rim 10. The sealing ring 33 is made of non-metallic material such as plastic material.

While we have shown and described the embodiment in accordance with the present invention, it should be clear to those skilled in the art that further embodiments may be made without departing from the scope of the present invention.

What is claimed is:

1. A positioning device for connecting a spoke to a wheel rim which includes holes defined through an inner periphery thereof, the positioning device comprising:
a base having an enlarged head and a shank extending from the enlarged head, a threaded hole defined through the shank, the shank being adapted to extend through one of the holes in the rim and the threaded hole being adapted to be connected to an end of the spoke, and
a sealing ring mounted to the shank of the base and adapted to seal the hole of the rim.

2. The device as claimed in claim 1, wherein the shank includes a polygonal section which is adapted to extend beyond the hole of the rim.

3. The device as claimed in claim 1, wherein the sealing ring is made of non-metallic material.

4. The device as claimed in claim 3, wherein the sealing ring is made of plastic material.

5. A positioning device for connecting a spoke to a wheel rim which includes holes defined through an inner periphery thereof, the positioning device comprising:
a sleeve member having a flange extending outward from an end thereof and a passage defined through the sleeve member, the other end of the sleeve member extending through one of the holes of the rim;
a base having an enlarged head and a shank extending from the enlarged head, the shank extending through the passage of the sleeve member, a threaded hole defined through the shank and being adapted to be connected to an end of the spoke, and
a sealing ring mounted to the sleeve member and adapted to seal the hole of the rim.

6. The device as claimed in claim 5, wherein the shank of the base includes a polygonal section which extends beyond an end of the sleeve member.

7. The device as claimed in claim 5, wherein the sealing ring is made of non-metallic material.

8. The device as claimed in claim 7, wherein the sealing ring is made of plastic material.
